(19) United States
(12) Patent Application Publication
(10) Pub. No.: US 2010/0090816 A1
(43) Pub. Date: Apr. 15, 2010

(54) Computer Screen Blanking Systems

(76) Inventors: Dick Hirsch, Phoenix, AZ (US); Doug Mayer, West Chester, OH (US)

Correspondence Address: LAW OFFICE OF ANDREW P. LAHSER, PLC, 16824 E. Avenue of the Fountains, Suite 14, FOUNTAIN HILLS, AZ, 85268, US

(21) Appl. No.: 12/538,012

(22) Filed: Aug. 7, 2009

Related U.S. Application Data
(60) Provisional application No. 61/188,460, filed on Aug. 8, 2008.
(60) Provisional application No. 61/087,625, filed on Aug. 8, 2008.

(51) Int. Cl. B60Q 1/00

(52) U.S. Cl. 340/438

(57) ABSTRACT

A system for detecting vehicular motion to blank a computer screen. The system includes filtering the motion to determine whenever the motion is consistent with vehicular motion. The system includes communicating the vehicular motion to a computer. The system includes blanking the screen of the computer whenever detecting vehicular motion and blanking the screen of the computer whenever the motion detector is not attached the portable computer.

### CROSS REFERENCE TO RELATED APPLICATIONS

The present application is related to prior provisional application Ser. No. 61/087,625, filed Aug. 8, 2008, the contents of which are incorporated herein by this reference and are not admitted to be prior art with respect to the present invention by the mention in this cross-reference section.

The present application is related to prior provisional application Ser. No. 61/188,460, filed Aug. 8, 2008, the contents of which are incorporated herein by this reference and are not admitted to be prior art with respect to the present invention by the mention in this cross-reference section.

### BRIEF DESCRIPTION OF THE DRAWINGS

FIG. 1 shows a diagrammatic view illustrating a system to detect vehicular movement and to blank a laptop computer screen, according to an embodiment.

FIG. 2 shows a diagrammatic view illustrating a device for attaching to a laptop computer that detects motion and vibration, according to the embodiment of FIG. 1.

FIG. 3A shows a diagrammatic view illustrating a laptop computer in use inside a moving vehicle with the laptop's screen partially blanked out and showing a navigation program, according to an embodiment.

FIG. 3B shows a diagrammatic view illustrating a laptop computer in use inside a stationary vehicle with a laptop screen fully functional, according to an embodiment.

FIG. 3C shows a diagrammatic view illustrating a laptop computer in use inside a home without a motion detector attached and with the screen completely blanked out, according to an embodiment.

FIG. 4 shows a diagrammatic view illustrating a process to blank out a computer screen whenever vehicle motion is detected or the motion detector is not attached to the computer, according to an embodiment.

FIG. 5A shows a computer screenshot view illustrating a user interface to test and to configure the software filter using parameters that assist in characterizing vehicular motion, according to an embodiment.

FIG. 5B shows a computer screenshot view illustrating a user interface to test communication with the motion detector, which is presently showing the absence of communication on the USB port, according to the embodiment of FIG. 5A.

FIG. 5C shows a computer screenshot view illustrating a user interface to test and to configure the software filter, which is presently showing that motion is detected, according to the embodiment of FIG. 5A.

FIG. 6 shows a tabular view illustrating a log file to report whenever vehicle motion is detected and the screen is blanked, according to an embodiment.

### DETAILED DESCRIPTION

The present Computer Screen Blanking Systems will now be discussed in detail with regard to the attached drawing figures, which were briefly described above. In the following description, numerous specific details are set forth illustrating the Applicant's best mode for practicing the Computer Screen Blanking Systems and enabling one of ordinary skill in the art to make and use the Computer Screen Blanking Systems. It will be obvious, however, to one skilled in the art that the present Computer Screen Blanking Systems may be practiced without many of these specific details. In other instances, well-known electrical engineering practices, methods, computer systems, interface designs, software systems, business methods and other method steps have not been described in particular detail in order to avoid unnecessarily obscuring this disclosure.

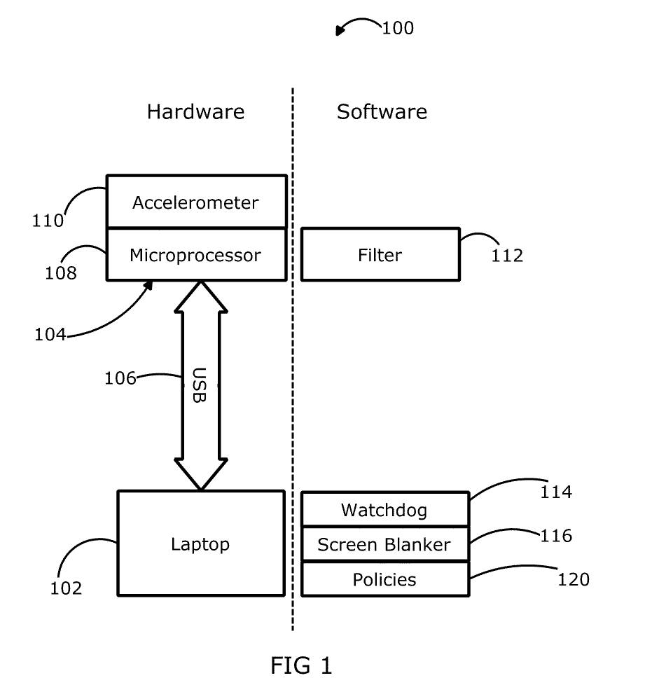

FIG. 1 shows a diagrammatic view illustrating a system to detect vehicular movement and to blank a laptop computer screen, according to an embodiment. System 100 includes hardware and software capable of detecting motion, characterizing whenever the motion may be caused by vehicular movement, and blanking a connected laptop computer screen in order to prevent the driver of the vehicle from becoming distracted. With the prevalence of portable computers, including laptop computers, vehicle drivers may have a laptop computer within eyesight while driving. Viewing a computer system while driving may increase the likelihood of a traffic accident because the driver may not be paying attention to the road or traffic conditions. For example, system 100 may improve safety while operating a motor vehicle by turning off, or blanking, the computer screen whenever the vehicle is in motion.

System 100 includes laptop 102 and motion detector 104, as shown. Motion detector 104 may be connected to laptop 102 by USB 106, as shown. Laptop 102 may be any suitable computer or computing means, such as, for example, portable computers, tablet computers, net books, or other general computing platforms capable of installing software programs that can communicate through a communications interface, etc.

USB 106 is also known as a universal serial bus, which is a standards-based interface for hardware devices to communicate with personal computers. USB 106 may be any suitable communication interface for allowing communications between a computer and a hardware device that expands its capability, such as, for example, an Ethernet port, a serial port, a parallel port, a WiFi connection, Bluetooth, etc. The communication interface may operably connect between a motion detector and a computer to transmit the filter's signals between the motion detector and the computer.

Motion detector 104 may be composed of microprocessor 108 and an accelerometer 110, as shown. Accelerometer 110 may be any suitable sensor to detect motion, such as, for example, a physical mechanism or electrical sensor that quantifies motion such that the motion can be integrated with an electrical circuit. Other sensors may include tilt sensors, vibration sensors, tilt and vibration sensors, etc. The sensor from Signal Quest with part number SQ-SEN-200-IBB may be used to detect motion.

Microprocessor 108 may be any suitable processor for filtering signals of the motion detector, such as, for example, a programmable integrated circuit, a reprogrammable processor, a microchip, etc. Microprocessor 108 may be a microchip PIC18F2450 or a microchip PIC16C745, either of which may include a USB interface, RISC architecture, and EPROM (erasable programmable read only memory) for storing firmware (for example, see software filter 112, below).

Motion detector 104 may include software filter 112, as shown. Software filter 112 may include a program for filtering motion, such as, for example, a program that can distinguish movement-of-a-vehicle-due-to-travel from movement-of-a-vehicle-due-to-engine-vibration. Software filter 112 may be able to characterize the type of movement, such as, for example, when the movement is due to acceleration or deceleration of a vehicle, turning of a vehicle, or when a vehicle is stopped. Software filter 112 may distinguish other types of movement, such as, for example, when a user is typing on a computer keyboard, a computer hard drive is spinning, etc. Software filter 112 may be any suitable filter or filter means, such as, for example, computer software programs, embedded systems, firmware, et cetera. Software filter 112 may filter the motion to determine whenever motion is consistent with vehicular motion of a vehicle.

Motion detector 104 may communicate whether vehicular movement has been detected via USB 106 to laptop 102, as shown. Motion detector 104 may communicate the lack of vehicular movement via USB 106 whenever the vehicle is at rest or vehicular motion is not detected. Motion detector 104 need not be attached to the vehicle. USB 106 may be a cable connection, such as, for example, using a 1 ft USB cable, a 3 ft USB cable, a 6 ft USB cable, etc. The cable connection may separate the motion detector from the laptop computer and prevent transmission of vibration (or dampen vibration) from usage of the computer (such as typing on the computer keyboard, hard drive vibration, etc.) from being transmitted to the motion sensor. In some embodiments, the communication interface may include a length of cable sufficient to dampen any vibration caused by the operation of the computer hardware. In other embodiments, the communication interface may not include a physical connection. In further embodiments, the communication interface may directly, fixedly, or rigidly attach the motion detector to the computer, such as, for example, without a cable, where the usb plug directly engages the usb receptacle. Motion detector 104 may be able to detect motion in any direction (360 degrees). Motion detector 104 may not need to be oriented in any preferred direction. Motion detector 104 may not need to be permanently connected to the vehicle. For example, motion detector 104 may detect motion with out modifying or altering the structure or systems of the vehicle.

Laptop 102 may receive communication from motion detector 104, as shown. Laptop 102 may pass the communication from motion detector 104 to screen blanker program 116, as shown. Screen blanker program 116 may disable, blank or otherwise prevent display of the laptop computer screen (or portions thereof, see also policies 120 and accompanying text) whenever vehicle motion may be communicated by motion detector 104. Screen blanker program 116 may disable, blank or otherwise prevent display of the laptop computer screen whenever no communication is received from any motion sensor. Screen blanker program 116 may be monitored by watchdog program 114, as shown. Screen blanker program 116 may be executed using operating system privileges that prevent non-administrative users (for example, vehicle drivers who are not authorized to change the configuration of the laptop) from stopping or shutting down the screen blanker program 116. The screen blanker program may be composed of one or more types of software program or components, such as, for example, an installable program, an operating system service, hardware drivers, function calls, modules or other type of machine-executable code that allows the computer to blank the screen of the computer whenever the filter determines the occurrence of vehicular motion or whenever the computer fails to receive signals from the motion sensor. Such a system may prevent driver distraction while a vehicle is in motion. Such a system may assist with compliance with laws and regulations that govern the use of laptops in vehicles. This system may allow a reduction in accidents and liabilities and associated costs. Some embodiments may be useful to reduce liabilities or accident costs for commercial transportation, including, buses, delivery vehicles, semi trucks, local delivery trucks, etc.

In some embodiments, the screen blanker program may not otherwise effect the operation of other software on the computer. The screen blanker program may not interfere with any other operation of the computer, for example, programs will continue to run, communications will continue, wireless connections will continue to operate, sounds will continue to be generated, etc. The screen blanker program will simply prevent visual distraction of the driver by the computer screen.

Watchdog program 114 may be an operating system service or other program that is started automatically by the operating system. Watchdog program 114 may monitor the execution of screen blanker program 116 or may detect when screen blanker program is not resident and executing in the memory of laptop 102. Watchdog program 114 may kill the screen blanker program 116 whenever watchdog program 114 determines that screen blanker program 116 may not be executing properly. Watchdog program 114 may restart the screen blanker program 116 whenever watchdog program 114 determines that screen blanker program 116 may not be presently running on laptop 102. Watchdog program 114 may otherwise monitor the functions of screen blanker program 116 to determine when screen blanker program 116 may not be executing or operating normally. Watchdog program 116 may be executed using operating system privileges that prevent non-administrative users (such as, for example, users who take laptops in vehicles) from stopping, shutting down, removing, or otherwise disabling the screen blanker program 116.

Policies 120 may be provided that determine which programs may be used when vehicle motion is detected. For example, a driving-navigation program may be allowed to be displayed when vehicle motion is communicated by motion detector 104 to laptop 102. A driving-navigation program may be a map or a global-positioning-system-enabled program for assisting driving a vehicle. Other driving-related programs may be allowed to be displayed while the system is detecting vehicular motion. Policies 120 may be provided that determine which users (administrative, groups, etc) may adjust the parameters of the screen blanker program 116, watchdog program 114, and other portions of the system. Security policies or operating system rights may prevent the program from being removed or disabled from the computer without sufficient administrative access rights for the operating system of the computer. Such a configuration will prevent vehicle operators from removing or disabling the system and thereby defeating the safety advantages. Polices 120 may be provided that determine which users or what operating system rights may be required to define what programs are “driving-related”. Policies 120 may allow the blanker module to display a portion of the screen related to operating the vehicle, such as, for example, allowing a GPS navigation program to display a map during vehicle motion while blanking all other portions of the screen. Policies 120 may be administered remotely or across a computer network or across a wireless network.

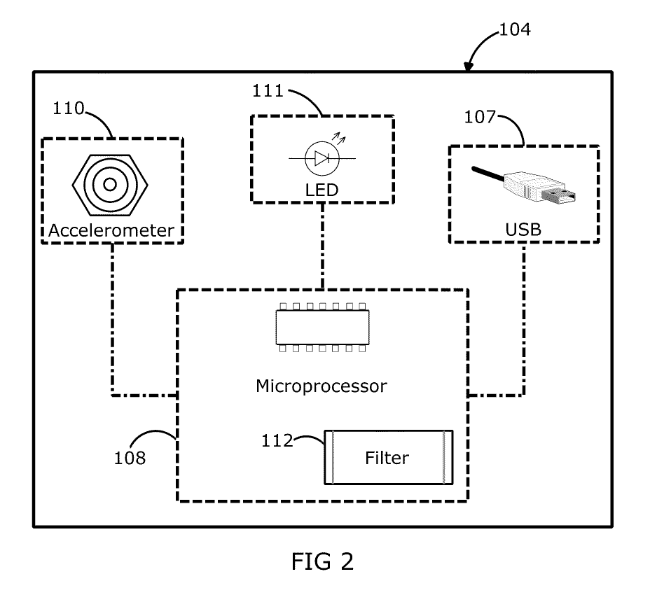

FIG. 2 shows a diagrammatic view illustrating a device for attaching to a laptop computer that detects motion and vibration, according to the embodiment of FIG. 1. Motion detector 104 may be connected to laptop 102, as shown. Motion detector 104 may include accelerometer 110, microprocessor 108, software filter 112 (which may be embedded in microprocessor 108 as firmware), LED 111, and USB connector 107, as shown. As illustrated, motion detector 104 may be removably attachable to laptop 102, as shown. In this configuration, motion detector 104 may be retrofitted on laptops or other computers used in vehicles well after the time of initial purchase. In this configuration, the motion detector may include only the single USB connector 107, which provides both the communication interface from the computer and power from the computer to operate motion detector 104. This may allow the motion detector 104 to be small, portable, and simple to use, connect and disconnect to the computer, which may assist embarking and disembarking the laptop from the vehicle.

In other embodiments, motion detector 104 may be included in the computer. In further embodiments, motion detector 104 may operate without a direct physical connection, rather, it may use a wireless communications interface to the laptop or computer and have a portable/rechargeable power source.

LED 111 may include one or more light emitting diodes. LED 111 may provide feedback to the user to indicate the activity of the motion detector 104, such as, for example, illuminating when powered on, indicating when motion is detected, indicating when operably connected to a computer, illuminating when a communication error is detected. In other embodiments, other methods of providing feedback to the user may be used, such as, for example, by emitting sounds or other feedback.

USB connector 107 may be any suitable connector appropriate to the type of communications interface. When using a universal serial bus (USB), the connector may be any type of receptacle or plug, including, USB-A, USB-B, Mini-B, Micro-A, Micro-B, or other type of connector.

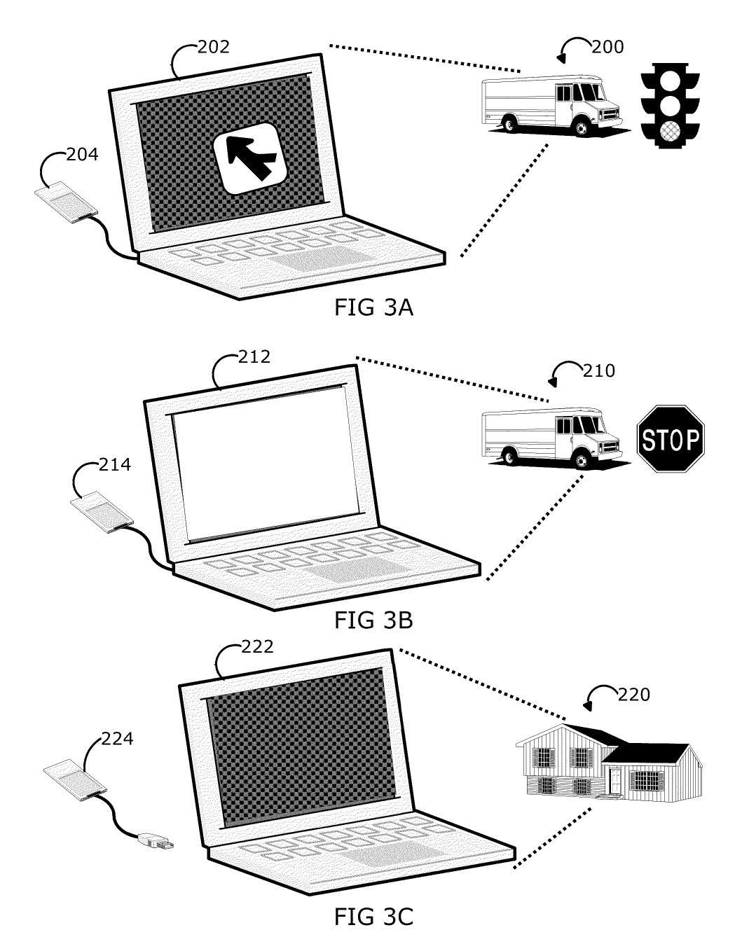

FIG. 3A shows a diagrammatic view illustrating laptop computer 202 in use inside moving vehicle 200 with the laptop's screen partially blanked out and showing a navigation program, according to an embodiment. Laptop computer 202 may be operably connected to motion detector 204, as shown. In this diagram, motion detector 204 has detected the movement of vehicle 200, and has transmitted a signal to laptop computer 202, as shown. Laptop computer 202 has received the signal, determined that a navigation program was being displayed on a portion of the screen, and has overlaid the entire computer screen, except for the screen area corresponding to the navigation program, as shown.

FIG. 3B shows a diagrammatic view illustrating laptop computer 212 in use inside a stationary vehicle 210 with a laptop screen fully functional, according to an embodiment. Laptop computer 212 may be operably connected to motion detector 214, as shown. In this diagram, motion detector 204 has detected no movement of vehicle 210, and has transmitted a signal to laptop computer 202, as shown. Laptop computer 202 has received a signal, determined that the vehicle is stationary, and has not blanked the screen.

FIG. 3C shows a diagrammatic view illustrating laptop computer 222 in use inside home 220 without motion detector 224 attached and with the screen completely blanked out, according to an embodiment. Laptop computer 222 has been detached from motion detector 224, as shown, perhaps because the motion detector required detachment to remove laptop computer 222 from a vehicle and carry laptop computer 224 into home 220. In this diagram, laptop computer 222 can not communicate with motion detector 224, and, the screen blanking software on laptop computer 222 may completely blank the screen to prevent users from disabling or defeating the safety features.

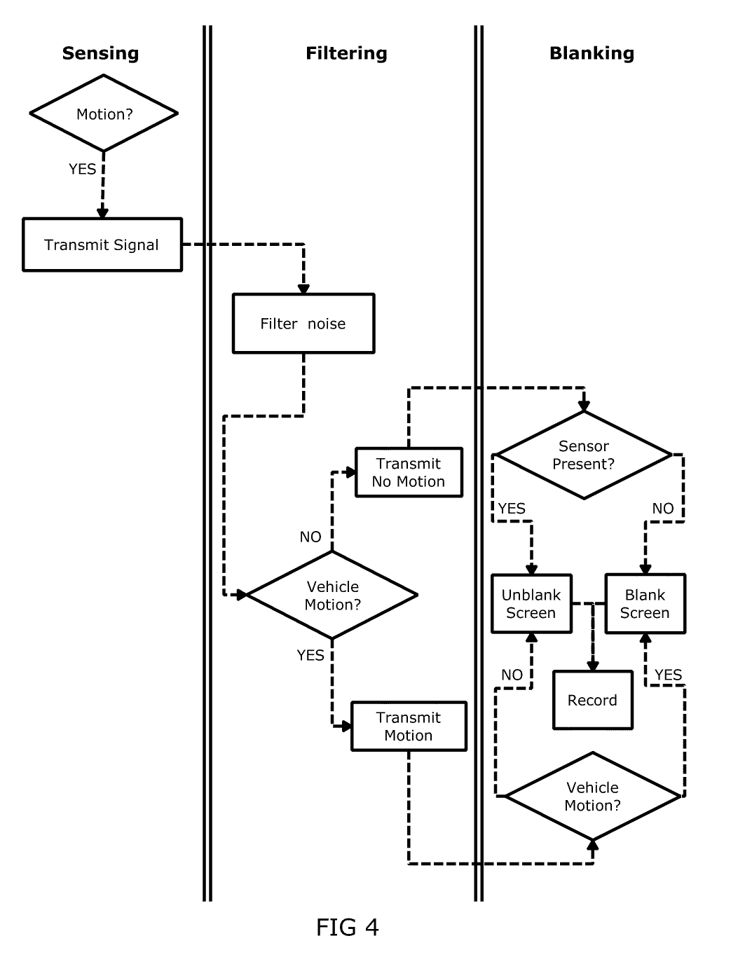

FIG. 4 shows a diagrammatic view illustrating process 300 to blank out a computer screen (or a portion of the screen not related to vehicle operation) whenever vehicle motion is detected or the motion detector is not attached to the computer, according to an embodiment. Decision 302 begins by deciding or detecting whether there is motion, vibration, or other physical sensation detectable by the sensor, as shown. The sensor may detect motion that may occur without permanently attaching the sensor to the vehicle. For example, decision 302 may detect motion without modifying or altering the structure or systems of the vehicle. Decision 302 may occur using any motion-detecting means capable of detecting motion, such as, for example, the motion detectors and motion sensors accompanying FIGS. 1, 2, 3, and 5.

Process 304 transmits a signal to the filter corresponding to the detected physical sensation, as shown. Process 306 may be configured with a profile to assist characterizing the vibration characteristics of the vehicle, such as, for example, considering engine vibration, suspension type, tire tread, and other sources of mechanical vibration. Such profiling of the vibration characteristics of the vehicle maybe done by testing. Alternately, a series of profiles may developed according to the class of vehicle, such as, for example, passenger vehicles, vehicles with 8 cylinder engines, semi-trucks, vehicles with trailers attached, delivery vehicles, etc. Process 306 may use this profiling to assist reducing noise using the vibration characteristics. Noise reducing means may include any structure or process for disregarding motion that was detected by the motion sensor, but, may not be characterized as due to vehicular motion.

Process 306 filters the noise from the signal to characterize the signal as vehicular motion or not. For example, process 306 filters the motion to determine whenever the motion is consistent with vehicular motion. Process 306 may include any filtering means, capable of determining whether the motion is consistent with vehicular motion, such as, for example, the filtering means discussed in FIGS. 1, 2, 3, and 5.

Decision 308 determines whether to send a signal corresponding to vehicular motion or non-motion. If vehicular motion is detected, process 310 transmits a signal to the blanking program. For example, process 310 communicates the vehicular motion to the computer. Decision 312 determines whether the blanking program should blank the screen using process 314, or, unblank the screen, using process 316, as shown. For example, decision 312 allows blanking the screen of the computer after process 310 communicates the occurrence of vehicular motion. Process 314 may blank the screen and process 316 may unblank the screen without interfering with any other operations of the computer. Process 314 may blank the screen and process 316 may unblank the screen while permitting continuously showing portions of the screen related to operating the vehicle. Blanking may be any kind of disabling of the computer screen, for example, in some embodiments, blanking may occur by placing the screen in a low power state or turning off the screen. In other embodiments, blanking may occur by overlaying the screen with a uniform, non-distracting, or less-illuminating color, such as black, or dark colors.

Process 318 transmits a no motion signal to decision 320, which allows decision 320 to determine when the motion detector is not present, and allows blanking program to blank the screen using process 314, or, unblank the screen, using process 316, as shown. For example, decision 320 allows blanking the screen of the computer whenever the process 318 cannot communicate with the computer and communicating fails.

Process 312 and process 318 may include any communicating means capable of communicating the vehicular motion to a computer, such as, for example, the communicating methods discussed in FIGS. 1, 2, 3, 5 and 6.

Process 316 or 318 may include any blanking means for blanking the screen of the computer after communicating the occurrence of vehicular motion and for blanking the screen of the computer whenever the step of communicating fails.

After process 316 or 318, process 322 may record the details of the blanking or unblanking event, including the date, time, duration, vibration characteristic, keystroke, or other desirable information.

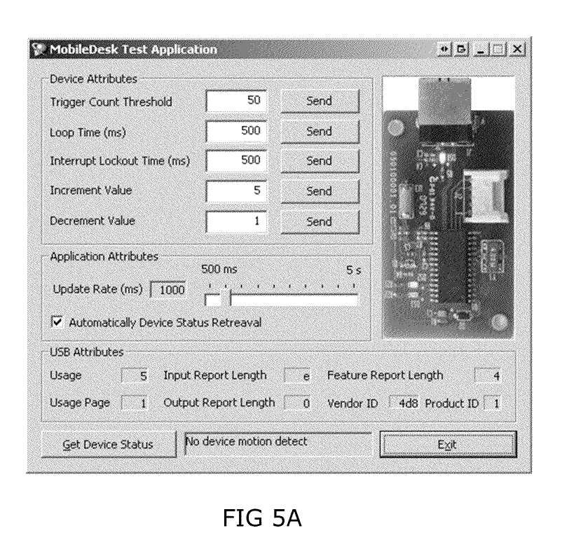

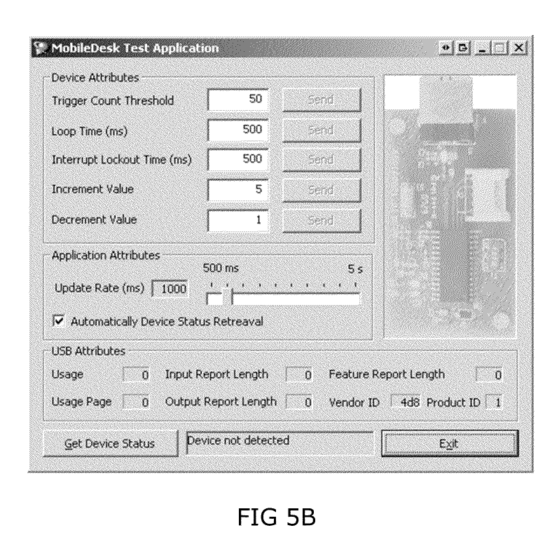

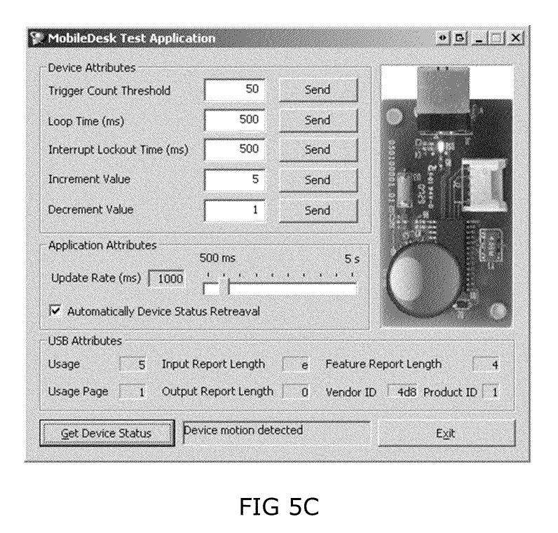

FIG. 5A shows a computer screenshot view illustrating a user interface to test and to configure the software filter using parameters that assist in characterizing vehicular motion, according to an embodiment. FIG. 5B shows a computer screenshot view illustrating a user interface to test communication with the motion detector, which is presently showing the absence of communication on the USB port, according to the embodiment of FIG. 5A. FIG. 5C shows a computer screenshot view illustrating a user interface to test and to configure the software filter, which is presently showing that motion is detected, according to the embodiment of FIG. 5A. This user interface allows adjustment of the software filter. The software filter may be any suitable program or data for determining, assisting to determine, or characterizing the motion, such as, for example, providing parameters that characterize the vehicle motion to the software filter installed as firmware in the motion detector. The digital software filter may be pre-installed upon the programmable integrated circuit of the motion sensor. The parameter attributes for configuring a vehicle motion characteristic profile include trigger count threshold, loop time, interrupt lockout time, increment value, and decrement value, which are indicative of the parameters used in such a digital software filter. In alternate embodiments, signal processing and digital filtering may occur on a program installed upon the laptop. In further embodiments, other type of characteristics, profiles, or information about the vibration of the vehicle may be used to assist identifying vehicular motion.

In some other embodiments, no graphical user interface will be required, because, this system may work without input from the user.

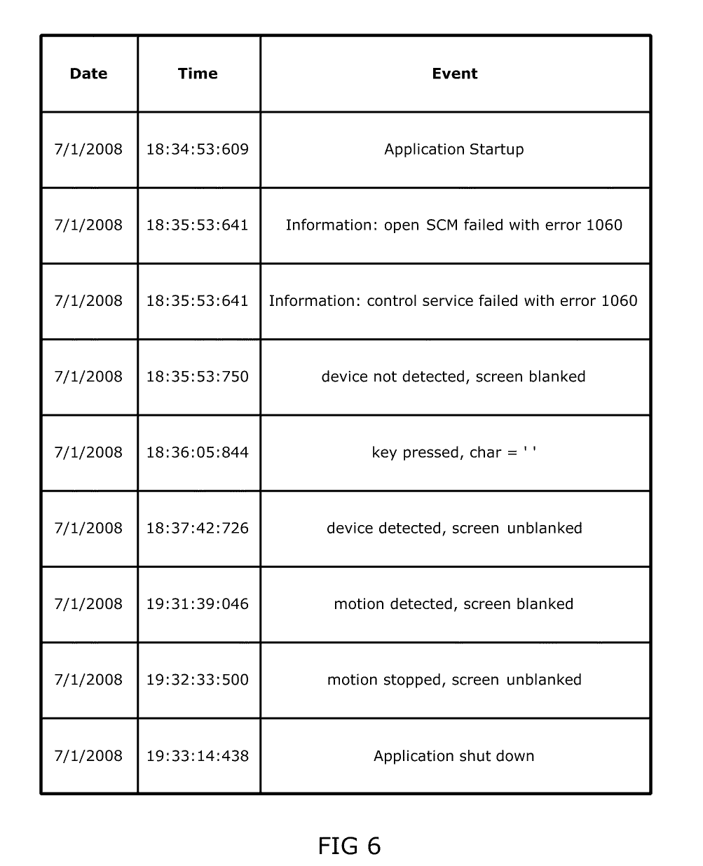

FIG. 6 shows a tabular view illustrating a log file to report whenever vehicle motion is detected and the screen is blanked, according to an embodiment. The log file shows the date, time, and a message. The types of messages may include the following:
1. Program startup (the program has been loaded by the operating system and started reporting to the log file);
2. Informational and warning messages (the program has experienced a problem or error);
3. Communications failure (the program cannot communicate with the device and has blanked or disabled the computer screen);
4. Key presses;
5. Screen blanking messages; and
6. Screen unblanking messages.
   The log file may assist determining when and how a vehicle is being used. For example, at the time of a vehicle accident, the log file may show whether the laptop screen was blank (and therefore, not being used), whether the user was interacting with the system, whether the system was properly operating at the time of the accident, etc. For example, the log file may show laptop usage habits of drivers while performing duties pursuant to their employment. The log file may be formatted for import into computer databases or spreadsheets, such as, for example, using comma separated values format.

A portion of the disclosure of this patent document contains material which is subject to copyright protection; i.e. Copyright 2008 Mobile Desk (17 U.S.C. 401). The copyright owner has no objection to the facsimile reproduction by anyone of the patent document or the patent disclosure, as it appears in the Patent and Trademark Office patent file or records, but otherwise reserves all copyright rights whatsoever.

Although Applicant has described Applicant's preferred embodiments, it will be understood that the broadest scope includes modifications and implementations apparent to those skilled in the art after reading the above specification and the below claims. Such scope is limited only by the below claims as read in connection with the above specification. Further, many other advantages of Applicant's disclosure will be apparent to those skilled in the art from the above descriptions and the below claims.

What is claimed is:

1. A system comprising the steps of:
a. detecting motion;
b. filtering the motion to determine whenever the motion is consistent with vehicular motion;
c. communicating the vehicular motion to a computer;
d. blanking the screen of the computer after the step of communicating the vehicular motion; and
e. blanking the screen of the computer whenever the step of communicating fails.

2. The system of claim 1 wherein:
a. the step of detecting motion occurs without altering the vehicle.

3. The system of claim 1 wherein:
a. the step of blanking the screen occurs without interfering with any other operations of the computer.

4. The system of claim 1 wherein:
a. the steps of blanking the screen permits showing portions of the screen related to operating the vehicle.

5. The system of claim 1 further comprising the step of:
a. profiling the vibration characteristics of the vehicle;
b. wherein the step of filtering the motion comprises the step of reducing noise using the vibration characteristics.

6. The system of claim 1 wherein:
a. the steps of blanking the screen further comprises the step of recording the date and time.

7. The system of claim 1 further comprising the step of:
a. profiling the vibration characteristics of the vehicle;
b. wherein the step of filtering the motion comprises the step of reducing noise using the vibration characteristics;
c. wherein the step of detecting motion occurs without connecting directly to the vehicle;
d. wherein the steps of blanking the screen occurs without interfering with any other operations of the computer; and
e. wherein the steps of blanking the screen permits showing portions of the screen related to operating the vehicle.

8. A system comprising:
a. a motion detector to detect motion;
b. a filter to filter the motion to determine whenever motion is consistent with vehicular motion of a vehicle;
c. a communication interface operably connected between the motion detector and a computer to transmit the signals of the filter between the motion detector and the computer; and
d. a program on the computer to blank the screen of the computer whenever the filter determines vehicular motion or whenever the computer fails to receive signals from the motion detector.

9. The system of claim 8 wherein:
a. the motion detector is not permanently attached to the vehicle.

10. The system of claim 8 wherein:
a. the communication interface comprises a length of cable sufficient to dampen any vibration caused by the operation of the computer hardware.

11. The system of claim 8 wherein:
a. communication interface comprises a universal serial bus.

12. The system of claim 8 wherein:
a. the program does not interfere with any other operation of the computer.

13. The system of claim 8 wherein:
a. the program cannot be removed or disabled from the computer without administrative access rights for the operating system of the computer.

14. The system of claim 8 wherein:
a. the motion detector comprises a tilt and vibration sensor;
b. the communication interface comprises a universal serial bus;
c. the filter comprises a reprogrammable microprocessor.

15. The system of claim 8 wherein:
a. the program comprises
i. a blanker module to blank the screen, and
ii. a watchdog module to watch the blanker module and to restart the blanker module whenever the blanker module is not executing on the computer.

16. The system of claim 15 wherein:
a. the program further comprises policies to allow the blanker module to display a portion of the screen related to operating the vehicle.

17. The system of claim 16 wherein:
a. the program does not interfere with any other operation of the computer;
b. the program cannot be removed or disabled from the computer without administrative rights;
c. the motion detector comprises a tilt and vibration sensor;
d. the motion detector is not fixedly attached to the vehicle;
e. the motion detector does not have a preferred orientation;
f. the communication interface comprises a universal serial bus;
g. the communication interface comprises a length of cable sufficient to dampen any vibration caused by the operation of the computer hardware;
h. the communication interface comprises a universal serial bus;
i. the filter comprises a reprogrammable microprocessor; and
j. the computer comprises a laptop computer.

18. A system comprising:
a. motion-detecting means for detecting motion;
b. filtering means for filtering the motion to determine whenever the motion is consistent with vehicular motion;
c. communicating means for communicating the vehicular motion to a computer;
d. blanking means for blanking the screen of the computer after the step of communicating the vehicular motion and for blanking the screen of the computer whenever the step of communicating fails.

19. The system of claim 18 further comprising:
a. profiling means for profiling the vibration characteristics of the vehicle;
b. wherein the filtering means comprises noise reducing means for reducing noise using the vibration characteristics.

20. The system of claim 19 wherein:
a. the motion-detecting means operates without permanently attaching to the vehicle;
b. the blanking means operates without interfering with any other operations of the computer; and
c. the blanking means comprises profiling means for profiling portions of the screen for display during operating of the vehicle.
